(19) United States
(12) Patent Application Publication
(10) Pub. No.: US 2023/0404127 A1
(43) Pub. Date: Dec. 21, 2023

(54) NUTRITIONAL COMPOSITIONS AND METHODS FOR REDUCING INADEQUATE NUTRITIONAL INTAKE OF A PALEO DIET

(71) Applicant: SOCIETE DES PRODUITS NESTLE S.A., Vevey (CH)

(72) Inventors: LOLITA BAZAROVA, Lausanne 26 (CH); PALOMA ELORTEGUI PASCUAL, Epalinges (CH); FABIO MAINARDI, Lausanne (CH); ROKO PLESTINA, Morges (CH); ERIC SCUCCIMARRA, Lausanne (CH)

(21) Appl. No.: 18/251,282

(22) PCT Filed: Nov. 1, 2021
(86) PCT No.: PCT/EP2021/080231

§ 371 Date: May 1, 2023

(30) Foreign Application Priority Data
Nov. 2, 2020 (EP) 20205214.8

(51) Int. Cl. A23L 33/00; A23L 33/16; A23L 33/21; A23L 33/155

(52) U.S. Cl. CPC A23L 33/30; A23L 33/16; A23L 33/21; A23L 33/155

(57) ABSTRACT

The present invention relates to nutritional compositions and methods to reduce the inadequate nutrient intake of a Paleo diet.

### FIELD OF THE INVENTION

The present invention relates to novel nutritional compositions and methods to reduce inadequate nutrient intake of a Paleo diet.

### BACKGROUND TO THE INVENTION

The Paleo diet was developed to mimic the original diet of humans from the perspective of the original paleolithic hunter-gatherers (Cordain, 2010). It purports to comprise the basic foods eaten by humans over a million years ago.

As many of the foods from Paleolithic times no longer exist in the present day, the modern Paleo diet recommendations mimics the foods that humans would have consumed in our historic past without the use of modern agricultural methods, animal husbandry, or processed foods, elements that have only existed for a short amount of time relative to the span of human evolution. Thus, the modern Paleo diet, focuses on nutrient-dense foods such as vegetables and fruits, lean meats and seafood while eliminating foods such as grains, dairy, refined sugars, refined oils, and processed foods.

Advantages of adherence to a Paleo diet are the resulting potential health benefits such as: weight loss, improved glucose tolerance, better blood pressure control, lower triglycerides and better appetite management.

Critics of the Paleo diet have pointed out that it oversimplifies the evolution of the human diet over time. It does not address the large variations in diet based on geography, climate and food availability as not only the transition to farming has shaped the evolution of nutritional needs. Archaeological evidence has shown that early human diets may have also included some wild grains before the introduction of farming. Further, genetic evolution has occurred in humans over time leading to an adaptive increase in the number of genes related to the breakdown of dietary starches which are found in various processed foods.

Nevertheless, the long-term impact of the Paleo diet and its relationship to inadequate nutrient intakes have received little attention. For this reason, there is a need to identify inadequate nutrient intakes associated with the Paleo diet and provide solutions in the form of nutritional compositions and methods to help the consumer of a Paleo diet reach the recommended daily allowance of nutrients.

### SUMMARY OF THE INVENTION

The primary difference between the Paleo diet and other healthy diets is the absence of whole grains and legumes, which are considered good sources of fiber, vitamins and other nutrients. In addition, the Paleo diet eliminates dairy products, which are good sources of protein and calcium. These exclusions from the diet lead to specific inadequate nutrient intakes.

The present invention addresses the inadequate nutrient intakes in the state of the art by providing new nutritional recommendations and innovative methods for personalized, diet and lifestyle recommendations for individual users who are adhering to a Paleo diet.

In particular, the present invention addresses the specific condition of dietary inadequate intake of a Paleo diet, by providing a novel, consolidated dietary recommendations which combine:
specific dietary components recommended to be consumed daily by gender and age,
specific dietary intake amounts by gender and age,
specific recommendations which comply with the overall Paleo diet restrictions related to avoiding certain dietary components, and
specific recommendations on lifestyle components.

### DESCRIPTION OF FIGURES

FIG. 1—Calcium

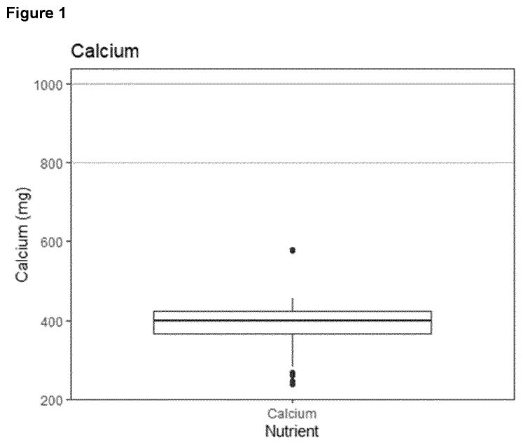

The box plot for calcium shows the amount of calcium in the diet compared to the estimated average requirement (EAR).

FIG. 2—Food folate

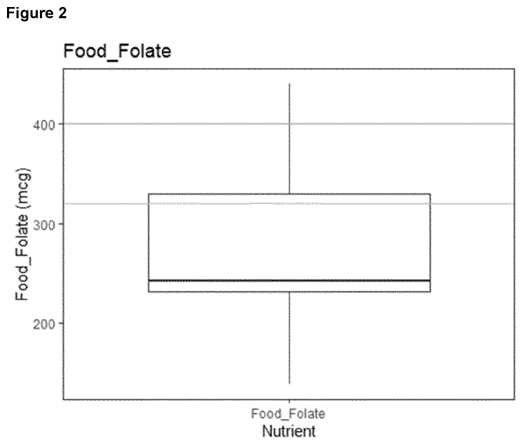

The box plot for food folate shows the amount of folate in the diet compared to the estimated average requirement (EAR).

FIG. 3—Magnesium

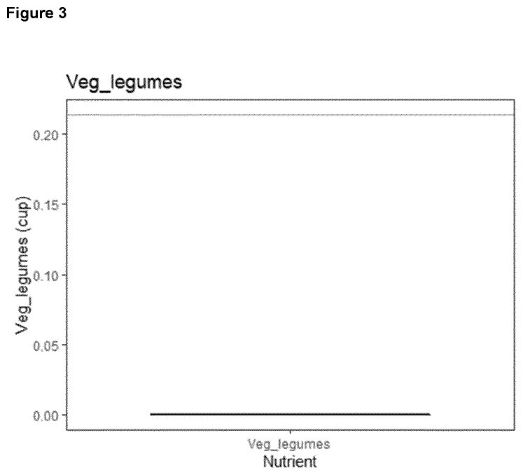

The box plot for magnesium shows the amount of magnesium in the diet compared to the estimated average requirement (EAR).

FIG. 4—Potassium

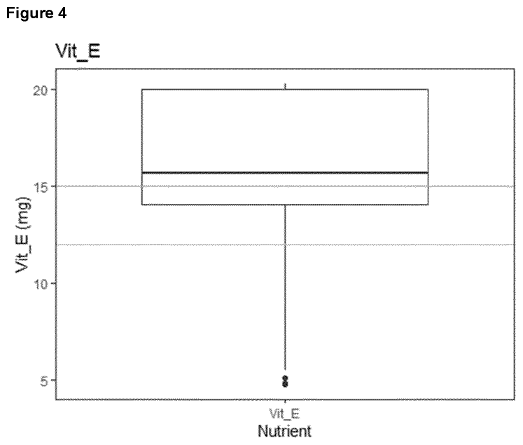

The box plot for potassium shows the amount of potassium in the diet compared to the estimated average requirement (EAR).

FIG. 5—Riboflavin

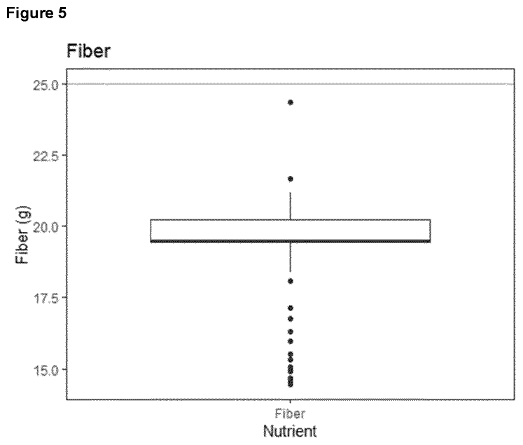

The box plot for riboflavin shows the amount of riboflavin in the diet compared to the estimated average requirement (EAR).

FIG. 6—Vitamin A

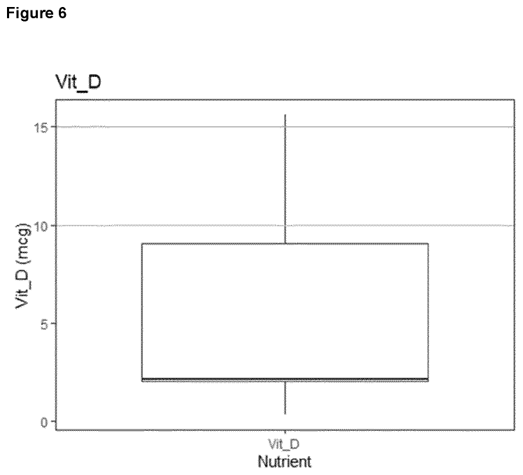

The box plot for Vitamin A shows the amount of Vitamin A in the diet compared to the estimated average requirement (EAR).

FIG. 7—Vitamin D

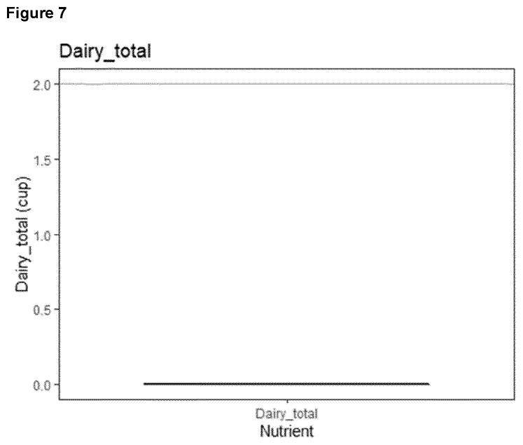

The box plot for Vitamin E shows the amount of Vitamin E in the diet compared to the estimated average requirement (EAR).

FIG. 8—Vitamin K

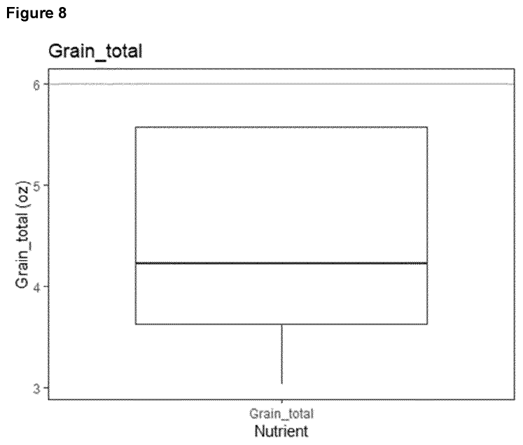

The box plot for Vitamin K shows the amount of Vitamin K in the diet compared to the estimated average requirement (EAR).

### DETAILED DESCRIPTION OF THE INVENTION

The present invention provides a composition for reducing inadequate nutrient intakes of individuals on a Paleo restricted diet.

In several embodiments, the composition for reducing inadequate nutrient intakes of individuals on a Paleo restricted diet comprises:
(a) for men 19-70 years old between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K;
(b) for men greater than 70 years old between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K;
(c) for women 19-50 years old between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K;
(d) for women greater than 50 years old between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

In several embodiments, the composition for reducing inadequate nutrient intakes of individuals on a Paleo restricted diet may be a food product, beverage product, a food supplement, an oral nutritional supplement (ONS), a medical food, and combinations thereof.

In several embodiments, the composition for reducing inadequate nutrient intakes of individuals on a Paleo restricted diet is an oral nutrient supplement administered as a single supplement or multiple separate supplements comprising:
(a) for men 19-70 years old between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K;
(b) for men greater than 70 years old between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K;
(c) for women 19-50 years old between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K; and
(d) for women greater than 50 years old between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

In another embodiment, the composition for reducing inadequate nutrient intakes of individuals on a Paleo restricted diet is an oral nutrient supplement administered as a single supplement consisting of a selection of at least one of the following components:
(a) for men 19-70 years old between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; or up to 107 mcg/day vitamin K.

In another preferred embodiment, the composition for reducing inadequate nutrient intakes of individuals on a Paleo restricted diet is an oral nutrient supplement administered as a single supplement consisting of a selection of at least one of the following components:
(b) for men greater than 70 years old between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; or up to 106 mcg/day vitamin K.

In another preferred embodiment, the composition for reducing inadequate nutrient intakes of individuals on a Paleo restricted diet is an oral nutrient supplement administered as a single supplement consisting of a selection of at least one of the following components:
(c) for women 19-50 years old between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; or up to 77 mcg/day vitamin K.

In another preferred embodiment, the composition for reducing inadequate nutrient intakes of individuals on a Paleo restricted diet is an oral nutrient supplement administered as a single supplement consisting of a selection of at least one of the following components:
(d) for women greater than 50 years old between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; or up to 80 mcg/day vitamin K.

In another embodiment, the composition for reducing inadequate nutrient intakes of individuals on a Paleo restricted diet is an oral nutrient supplement administered as a single supplement consisting of the following components:
(a) for men 19-70 years old between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K.

In another preferred embodiment, the composition for reducing inadequate nutrient intakes of individuals on a Paleo restricted diet is an oral nutrient supplement administered as a single supplement consisting of a selection of at least one of the following components:
(b) for men greater than 70 years old between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K.

In another preferred embodiment, the composition for reducing inadequate nutrient intakes of individuals on a Paleo restricted diet is an oral nutrient supplement administered as a single supplement consisting of a selection of at least one of the following components:
(c) for women 19-50 years old between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K.

In another preferred embodiment, the composition for reducing inadequate nutrient intakes of individuals on a Paleo restricted diet is an oral nutrient supplement administered as a single supplement consisting of a selection of at least one of the following components:
(d) for women greater than 50 years old between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

In several embodiments, the composition for reducing inadequate nutrient intakes of individuals on a Paleo restricted diet may comprise a mixture of food products, beverage products and oral nutrient supplements.

In several embodiments, the present invention provides a method of preventing or treating inadequate nutrient intakes of a Paleo diet comprising administration of a composition consisting of:
(a) for men 19-70 years old between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K;
(b) for men greater than 70 years old between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K;
(c) for women 19-50 years old between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K; or
(d) for women greater than 50 years old between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

In several embodiments, the present invention provides a kit of parts comprising meal recommendations, recipes, or menus for individuals on a Paleo restricted diet wherein said kit includes a composition according to the invention.

### Definitions

The “Paleo diet” as used herein is also known as the “Paleolithic diet”, “Caveman diet”, or “Stone-age diet”. Strict adherence to this diet avoids processed food and typically includes vegetables, fruits, nuts, roots, and meat and excludes dairy products, grains, refined sugars, legumes, refined oils, processed foods and alcohol.

Dietary Reference Intake (DRI)

Dietary Reference Intake (DRI) is a system of nutrition recommendations from the Institute of Medicine (IOM) of the National Academies (United States) introduced in 1997 in order to broaden the existing guidelines known as Recommended Dietary Allowances (RDAs).

Recommended Daily Allowance (RDA)

Recommended Dietary Allowances (RDA) is the daily dietary intake level of a nutrient considered sufficient to meet the requirements of 97.5% of healthy individuals in each life-stage and sex group. The definition implies that the intake level would cause an inadequate nutrient intake in just 2.5%. It is calculated based on the Estimated Average Requirements (EAR) and is usually approximately 20% higher than the EAR.

If the standard deviation (SD) of the EAR is available and the requirement for the nutrient is symmetrically distributed, the RDA is set at two SDs above the EAR:

RDA=EAR+2SD (EAR)

If data about variability in requirements are insufficient to calculate an SD, a coefficient of variation (CV) for the EAR of 10 percent is assumed, unless available data indicate a greater variation in requirements. If 10 percent is assumed to be the CV, then twice that amount when added to the EAR is defined as equal to the RDA. The resulting equation for the RDA is:

RDA=1.2 (EAR)

This level of intake statistically represents 97.5% of the requirements of the population.

Estimated Average Requirements (EAR)

Estimated Average Requirements (EAR) for nutrients are calculated to satisfy the needs of 50% of the people in a specific age group based on a review of the scientific literature.

Adequate Intake (AI)

Adequate Intake (AI) for nutrients is the amount when no RDA has been established and it is based on what is considered to be adequate for a specific demographic group.

Tolerable Upper Intake Levels (UL)

Tolerable upper intake levels (UL), to caution against excessive intake of nutrients (such as fat soluble vitamins) that can be harmful in large amounts. This is the highest level of daily nutrient consumption that is considered to be safe for, and cause no side effects in, 97.5% of healthy individuals in each life-stage and sex group. The definition implies that the intake level would cause a harmful nutrient excess in just 2.5%.

Different national and regional authorities have different dietary reference values. For example, The European Food Safety Authority (EFSA) refers to the collective set of information as Dietary Reference Values (DRV), with Population Reference Intake (PRI) instead of RDA, and Average Requirement instead of EAR. AI and UL defined the same as in United States, but values may differ.

Composition

The term “composition” can mean a food, beverage, complete nutrition or oral nutritional supplement (ONS) or medical food composition.

The terms “food,” “food product” and “food composition” mean a product or composition that is intended for ingestion by an individual such as a human and provides at least one nutrient to the individual. The compositions of the present disclosure, including the many embodiments described herein, can comprise, consist of, or consist essentially of the essential elements and limitations described herein, as well as any additional or optional ingredients, components, or limitations described herein or otherwise useful in a diet.

In several embodiments, the “food,” “food product” and “food composition” provides at least one of calcium, fiber, folate, magnesium, potassium, riboflavin, vitamin A, vitamin K or vitamin D in a daily dosage amount in the following ranges depending on the age and sex of the consumer:
For men aged 19 to 70, between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K;
For men aged 71 and over, between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K;
For women aged 19 to 50 years old, between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K;
For women aged 51 and over, between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

The term “beverage”, “beverage product” and “beverage composition” mean a product or composition for ingestion by an individual such as a human and provides at least one nutrient to the individual. The compositions of the present disclosure, including the many embodiments described herein, can comprise, consist of, or consist essentially of the essential elements and limitations described herein, as well as any additional or optional ingredients, components, or limitations described herein or otherwise useful in a diet.

In several embodiments, the “beverage”, “beverage product” and “beverage composition” provides at least one of calcium, fiber, folate, magnesium, potassium, riboflavin, vitamin A, vitamin K or vitamin D in a daily dosage amount in the following ranges depending on the age and sex of the consumer:
For men aged 19 to 70, between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K;
For men aged 71 and over, between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K;
For women aged 19 to 50 years old, between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K;
For women aged 51 and over, between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

As used herein, “complete nutrition” contains sufficient types and levels of macronutrients (protein, fats and carbohydrates) and micronutrients to be sufficient to be a sole source of nutrition for the subject to which the composition is administered. Individuals can receive 100% of their nutritional requirements from such complete nutritional compositions.

In several embodiments, the “complete nutrition” composition provides at least one of calcium, fiber, folate, magnesium, potassium, riboflavin, vitamin A, vitamin K or vitamin D in a daily dosage amount in the following ranges depending on the age and sex of the consumer:
For men aged 19 to 70, between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K;
For men aged 71 and over, between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K;
For women aged 19 to 50 years old, between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K;
For women aged 51 and over, between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

The term “supplement” means a product or composition that is intended for ingestion by an individual, such as a human.

In one embodiment, the supplement is an oral nutritional supplement (ONS) and provides at least one of: calcium, fiber, folate, magnesium, potassium, riboflavin, vitamin A, vitamin K or vitamin D in a daily dosage amount.

In several embodiments, the supplement is an oral nutritional supplement and provides at least one of calcium, fiber, folate, magnesium, potassium, riboflavin, vitamin A, vitamin K or vitamin D in a daily dosage amount in the following ranges depending on the age and sex of the consumer:
For men aged 19 to 70, between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K.
For men aged 71 and over, between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K.
For women aged 19 to 50 years old, between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K.
For women aged 51 and over, between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

In one embodiment, the supplement contains calcium, fiber, folate, magnesium, potassium, vitamin A, vitamin K, riboflavin and vitamin D together in a single supplement.

In one embodiment, the supplement contains calcium, fiber, folate, magnesium, potassium, vitamin A, vitamin K, riboflavin and vitamin D together in multiple supplements.

In a preferred embodiment, the single or multiple supplements contain:
(a) for men 19-70 years old between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K;
(b) for men greater than 70 years old between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K;
(c) for women 19-50 years old between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K; or
(d) for women greater than 50 years old between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

The composition can be administered at least one day per week, preferably at least two days per week, more preferably at least three or four days per week (e.g., every other day), most preferably at least five days per week, six days per week, or seven days per week. The time period of administration can be at least one week, preferably at least one month, more preferably at least two months, most preferably at least three months, for example at least four months. In some embodiments, dosing is at least daily; for example, a subject may receive one or more doses daily, in an embodiment a plurality of doses per day. In some embodiments, the administration continues for the remaining life of the individual. In other embodiments, the administration occurs until no detectable symptoms of the inadequate nutrient intakes associated with a Paleo diet remain. In specific embodiments, the administration occurs until a detectable reduction of at least one inadequate nutrient intake selected from calcium, fiber, folate, magnesium, potassium, riboflavin, vitamin A, vitamin K or vitamin D occurs and, in further cases, continues to remain ameliorated.

The compositions disclosed herein may be administered to the subject enterally, e.g., orally, or parenterally. Non-limiting examples of parenteral administration include intravenously, intramuscularly, intraperitoneally, subcutaneously, intraarticularly, intrasynovially, intraocularly, intrathecally, topically, and inhalation. As such, non-limiting examples of the form of the composition include natural foods, processed foods, natural juices, concentrates and extracts, injectable solutions, microcapsules, nano-capsules, liposomes, plasters, inhalation forms, nose sprays, nosedrops, eyedrops, sublingual tablets, and sustained-release preparations.

Calcium

Non-limiting examples of suitable forms of calcium include one or more calcium salts, such as calcium acetate, calcium carbonate, calcium chloride, calcium citrate, calcium glubionate, calcium gluconate, calcium lactate or mixtures thereof.

Calcium may be consumed from food sources, for example, raw tofu prepared with calcium sulfate, oriental radish, or sesame seeds.

In several embodiments, calcium is administered in the amount per day of:
(a) for men 19-70 years old between 322 to 820 mg/day calcium
(b) for men greater than 70 years old between 537 to 1024 mg/day calcium;
(c) for women 19-50 years old between 303 to 823 mg/day calcium;
(d) for women greater than 50 years old between 503 to 1017 mg/day calcium; per day.

Fiber

Non-limiting suitable forms of fiber include fiber supplements from containing guar fiber, psyllium, glucomannan or β-glucans.

In one embodiment, fiber is in the form of food fiber. In several embodiments, fiber may be consumed from food sources, for example, passionfruit 10.0 g/100 g or raw oats.

In several embodiments, fiber is administered in the amount per day of:
(a) for men 19-70 years old between 9 to 27 g/day fiber;
(b) for men greater than 70 years old between 5 to 22 g/day fiber;
(c) for women 19-50 years old between 1 to 17 g/day fiber;
(d) for women greater than 50 years old up to 13 g/day fiber

Folate

Non-limiting suitable forms of folate include Vitamin B9 supplements.

In a preferred embodiment, folate is in the form of food folate. Food folate may be consumed from food sources, for example, from: chives, mushrooms (dried shiitake), raw spinach, oriental radish or agar seaweed.

In several embodiments, folate is administered in the amount per day of:
(a) for men 19-70 years old between between 66 to 337 mcg/day folate;
(b) for men greater than 70 years old between 67 to 337 mcg/day folate;
(c) for women 19-50 years old between 91 to 347 mcg/day folate;
(d) for women greater than 50 years old between 131 to 346 mcg/day folate.

Magnesium

Non-limiting suitable forms of magnesium include magnesium supplements.

In one embodiment, magnesium may be consumed from food sources such as rice bran, hulled hemp seed or Brazil nuts.

In several embodiments, magnesium is administered in the amount per day of:
(a) for men 19-70 years old up to 186 mg/day magnesium;
(b) for men greater than 70 years old up to 194 mg/day magnesium.

Potassium

Non-limiting suitable forms of potassium include potassium supplements.

In one embodiment, potassium may be consumed from food sources such as chives, radishes, mature raw soybeans, and bananas.

In several embodiments, potassium is administered in the amount per day of:
(a) for men 19-70 years old up to 1099 mg/day potassium;
(b) for men greater than 70 years old up to 1082 mg/day potassium; Riboflavin Non-limiting suitable forms of riboflavin include riboflavin supplements.

In one embodiment, riboflavin may be consumed from food sources such as, for example, beef liver or spirulina seaweed.

In several embodiments, riboflavin is administered in the amount per day of:
(a) for men greater than 70 years old, up to 0.7 mg/day riboflavin;
(b) for women 19-50 years old, up to 0.5 mg/day riboflavin.

Vitamin A

Non-limiting suitable forms of Vitamin A include Vitamin A supplements.

In one embodiment, Vitamin A may be consumed from food sources such as, for example, fish oil, sweet potato, or carrots.

In several embodiments, Vitamin A is administered in the amount of per day of:
(a) for men 19-70 years old up to 882 mcg/day vitamin A;
(b) for men greater than 70 years old up to 880 mcg/day vitamin A;
(c) for women 19-50 years old up to 690 mcg/day vitamin A;
(d) for women greater than 50 years old up to 692 mcg/day vitamin A

Vitamin D

Non-limiting suitable forms of Vitamin D include cod liver fish oil, fish or sunlight exposure.

In one embodiment, fish is administered in the amount of 100 g per day from the group of fish, for example, such as: swordfish, salmon, trout, sturgeon, whitefish, mackerel, tuna, halibut, herring, sardines, tilapia, flounder or sole.

In one embodiment, Vitamin D is in the form of 15 minutes of sunlight.

In several embodiments, Vitamin D is administered in the amount per day of:
(a) for men 19-70 years old up to 15 mcg/day Vitamin D;
(b) for men greater than 70 years old up to 20 mcg/day Vitamin D;
(c) for women 19-50 years old up to 15 mcg/day Vitamin D;
(d) for women greater than 50 years old up to 80 mcg/day vitamin K.

Vitamin E

Non-limiting suitable forms of Vitamin E include Vitamin E supplements.

In one embodiment, Vitamin E may be consumed from food sources such as, for example, spinach or broccoli.

In several embodiments, Vitamin E is administered in the amount of per day of:
(a) for men 19-70 years old up to 12 mg/day Vitamin E;
(b) for men greater than 70 years old up to 12 mg/day Vitamin E;
(c) for women 19-50 years old up to 12 mg/day Vitamin E;
(d) for women greater than 50 years old up to 12 mg/day Vitamin E.

Vitamin K

Non-limiting suitable forms of Vitamin K include Vitamin K supplements.

In one embodiment, Vitamin K may be consumed from food sources such as, for example, spinach, beet greens, or collards.

In several embodiments, Vitamin K is administered in the amount per day of:
(a) for men 19-70 years old up to 107 mcg/day vitamin K;
(b) for men greater than 70 years old up to 106 mcg/day vitamin K;
(c) for women 19-50 years old up to 77 mcg/day vitamin K; or
(d) for women greater than 50 years old up to 80 mcg/day vitamin K.

### REFERENCES

Cordain, L. (2010) The Paleo Diet: Lose Weight and Get Healthy by Eating the Foods You Were Designed to Eat. Revised edition, John Wiley & Sons, 2010

### EXAMPLES

### Example 1: Inadequate Nutrient Intakes of a Paleo Diet

In order to estimate the potential risk of nutrients inadequacies for specialty diets, without the use of randomized controlled trials (RCT) or traditional dietary assessment methods (for example: 24 hours food recall, food frequency questionnaire, food records), we simulated 500 to 1000 days of food intake in silico for a variety of individuals adhering to a Paleo diet with a digital tool.

The digital simulation tool simulates days of food intake by finding the optimal combination of available meals to maximize the nutritional balance subject to the specified Paleo diet constraints. In order to mimic real-world food intake as closely as possible, we used actual meals consumed by people as reported in the National Health And Nutrition Examination Survey (NHANES), a survey performed by the US Center for Disease Control and Prevention (CDC). This had the benefit of producing simulated diets which were realistic and are similar to those actually eaten in the US population.

The simulation tool allowed the user to specify the characteristics of the individual (sex, age, height, weight, physical activity level) in order to calculate the estimated energy requirement (EER) per day. The user could also specify his/her dietary pattern preferences—in this case, it was a Paleo diet preference. Additional criteria could be specified such as foods, food groups, and/or specific nutrients which should be excluded, minimized or maximized.

The simulation tool then used integer programming techniques to create in silico menu plans which optimize the nutritional balance of the overall diet subject to the specified constraints of the Paleo diet.

The nutritional balance of the simulated diets was maximized by minimizing the difference between the nutritional profile of the simulated diet and a baseline specified by the USDA Healthy Eating Patterns (HEP), which specified target amounts of food groups to be consumed on a daily and weekly basis. We also added additional nutrient level constraints such as upper limits on sodium, added sugars, and saturated fats. These guidelines were then adjusted based on the individual's EER to obtain desired amounts of food groups and nutrients to be consumed per day and per week. The objective of which was calculated as a scalar weighted linear combination of the differences for each individual food group and nutrient for the diet and the baseline.

For simulation of the Paleo diet the following constraints were implemented to enforce the rules of the diet:
No dairy, refined grains, alcohol, and legumes
No added sugar (as a proxy for processed foods)
Lower limit on protein from animal meat to enforce the high meat intake of the diet
Upper limit on sodium
Upper limit on cereal grains

Simulated diets were then created for 50 days at a time for men and women of varying ages, heights and weights. These diets were then aggregated and analysed using non-parametric statistical methods over the individual simulated days to identify intervals of likely nutritional nutrient inadequacies.

As there are different nutritional guidelines for men and women of different ages, the simulations were performed for the following groups:
Men 19-70 years old
Men 71+ years old
Women 19-50 years old
Women 51+ years old

The results of the analyses and the resulting recommendations for each group are below. These tables show the complete results of the analysis.
EAR is Estimated Average Requirement, the estimated amount which will meet the needs of 50% of the population
AI is Adequate Intake, a recommended average daily intake level, estimated observationally when an EAR cannot be established
HEP is Healthy Eating Pattern, which are food group level recommendations from the USDA

The recommendations are generated as ranges of amounts to cover 97.5% of the population, based on the quantiles of simulated intakes. The lower end of the range is derived from the deficiency of the 97.5% quantile, while the upper end is derived from the deficiency of the 2.5% quantile. The maximum tolerable intake is also accounted for when generated the recommendation ranges. The actual recommendation ranges are found in Tables 5,12,19 and 26 for each sex and age group.

Part 1—Results of Analysis for Males from 19 to 70 Years Old

TABLE 1
shows the nutrients which have been identified as being adequate,
inadequate and at risk for Males from 19 to 70 years old

| | | | | Mean. | Per. | |
|---|---|---|---|---|---|---|
| | | | Min. | Inade- | Defi- | Assess- |
| Nutrient | Type | Units | DRI | quacy | cient | ment |
| Calcium | EAR | mg | 860.000 | 512.033 | 1.00 | Inadequate |
| Dairy_total | HEP | cups | 3.000 | 3.000 | 1.00 | Inadequate |
| Fiber | AI | g | 34.800 | 16.940 | 1.00 | Inadequate |
| Food_Folate | EAR | μg | 320.000 | 119.315 | 1.00 | Inadequate |
| Grain_total | HEP | oz | 6.000 | 6.000 | 1.00 | Inadequate |
| Magnesium | EAR | mg | 346.000 | −91.563 | 0.20 | Adequate |
| Oils | HEP | NA | 29.000 | −9.405 | 0.20 | Adequate |
| Potassium | AI | mg | 3000.000 | −277.744 | 0.20 | At Risk |
| Riboflavin | EAR | mg | 1.100 | −0.321 | 0.00 | Adequate |
| Sodium | AI | mg | 1500.000 | −231.296 | 0.00 | Adequate |
| Veg_dark_green | HEP | oz | 0.257 | 0.113 | 0.84 | Inadequate |
| Veg_legumes | HEP | oz | 0.214 | 0.214 | 1.00 | Inadequate |
| Vit_A | EAR | μg | 625.000 | 209.096 | 1.00 | Inadequate |
| Vit_B6 | EAR | mg | 1.220 | −1.074 | 0.00 | Adequate |
| Vit_D | EAR | μg | 10.000 | 0.744 | 0.68 | Inadequate |
| Vit_E | EAR | mg | 12.000 | 0.141 | 0.40 | At Risk |
| Vit_K | AI | μg | 120.000 | 8.440 | 0.60 | Inadequate |
| Zinc | EAR | mg | 9.400 | −5.061 | 0.00 | Adequate |

Summary Quantiles on Intakes

Table 2 shows the summary statistics on intakes with quantiles for the nutrients of interest, along with the percentage of simulated days which are at or above the DRI. Note that for many of these the Max Intake is below the Min.DRI, indicating that there is close to 0% chance of adequacy.

TABLE 2
Summary Quantiles on Intakes for Males from 19 to 70 years old

| Nutrient | Units | Min.DRI | RDA | Min | 2.5% | 50% | 97.5% | Max | Pct.Adequate |
|---|---|---|---|---|---|---|---|---|---|
| Calcium | mg | 860.000 | 1000 | 106.257 | 179.869 | 298.200 | 677.435 | 999.768 | 0.002 |
| Dairy_total | cups | 3.000 | NA | 0.000 | 0.000 | 0.000 | 0.000 | 0.001 | 0.000 |
| Fiber | g | 34.800 | NA | 4.353 | 8.288 | 15.272 | 25.380 | 40.638 | 0.000 |
| Food_Folate | μg | 320.000 | 400 | 31.960 | 62.835 | 172.100 | 334.497 | 509.380 | 0.054 |
| Grain_total | oz | 6.000 | NA | 0.000 | 0.000 | 0.000 | 0.000 | 2.323 | 0.000 |
| Magnesium | mg | 346.000 | 416 | 149.415 | 229.975 | 354.846 | 669.876 | 854.220 | 0.524 |
| Potassium | mg | 3000.000 | NA | 1462.423 | 1900.886 | 2979.242 | 4408.707 | 5737.225 | 0.476 |
| Veg_legumes | oz | 0.214 | NA | 0.000 | 0.000 | 0.000 | 0.000 | 0.000 | 0.000 |
| Vit_A | μg | 625.000 | 900 | 3.310 | 17.775 | 503.919 | 1041.027 | 2850.993 | 0.232 |
| Vit_D | μg | 10.000 | 15 | 0.000 | 0.163 | 4.617 | 32.573 | 77.203 | 0.356 |
| Vit_E | mg | 12.000 | 15 | 1.397 | 3.086 | 7.994 | 23.489 | 36.245 | 0.248 |
| Vit_K | μg | 120.000 | NA | 5.424 | 13.317 | 49.433 | 488.595 | 792.290 | 0.220 |

Amount of Inadequacy

Table 3 shows the amount of inadequacy, below the DRI for each of the quantiles. If the values are negative it means that the intake tends to be above the DRI.

TABLE 3
Amount of Inadequacy by Quantiles
for Males from 19 to 70 years old

| Nutrient | Units | Min.DRI | 2.5% Gap | 50% Gap | 97.5% Gap |
|---|---|---|---|---|---|
| Calcium | mg | 860.000 | 680.131 | 561.800 | 182.565 |
| Dairy_total | cups | 3.000 | 3.000 | 3.000 | 3.000 |
| Fiber | g | 34.800 | 26.512 | 19.528 | 9.420 |
| Food_Folate | mcg | 320.000 | 257.165 | 147.900 | −14.497 |
| Grain_total | oz | 6.000 | 6.000 | 6.000 | 6.000 |
| Magnesium | mg | 346.000 | 116.025 | −8.846 | −323.876 |
| Potassium | mg | 3000.000 | 1099.114 | 20.758 | −1408.707 |
| Veg_legumes | oz | 0.214 | 0.214 | 0.214 | 0.214 |
| Vit_A | mcg | 625.000 | 607.225 | 121.081 | −416.027 |
| Vit_D | mcg | 10.000 | 9.837 | 5.383 | −22.573 |
| Vit_E | mg | 12.000 | 8.914 | 4.006 | −11.489 |
| Vit_K | mcg | 120.000 | 106.683 | 70.567 | −368.595 |

Nutritional Recommendations for Males from 19 to 70 years old

Table 4 shows the dietary recommendations and Table 5 shows the recommendation ranges. For recommendations we took the 2.5% quantile as the intake, the EAR (or Recommended daily Allowance (RDA), if available) as the goal, and divided it by 2 to get to recommendation per 1000 kCal, ensuring that the suggestion will be below the Max DRI.

Note that the food group recommendations (Dairy, Grains and Legumes) cannot be made because they are against the rules of the Paleo diet.

TABLE 4
Dietary Recommendations for Males from 19 to 70 years old

| Nutrient | Type | Units | DV | 1000 kCal Rec | 2000 kCal Rec |
|---|---|---|---|---|---|
| Calcium | EAR | mg | 1000.00 | 410.07 | 820.13 |
| Dairy_total | HEP | cups | 3.00 | 1.50 | 3.00 |
| Fiber | AI | g | 34.80 | 13.26 | 26.51 |
| Food_Folate | EAR | mcg | 400.00 | 168.58 | 337.17 |
| Grain_total | HEP | oz | 6.00 | 3.00 | 6.00 |
| Magnesium | EAR | mg | 416.00 | 93.01 | 186.02 |
| Potassium | AI | mg | 3000.00 | 549.56 | 1099.11 |
| Veg_legumes | HEP | oz | 0.21 | 0.11 | 0.21 |
| Vit_A | EAR | mcg | 900.00 | 441.11 | 882.23 |
| Vit_D | EAR | mcg | 15.00 | 7.42 | 14.84 |
| Vit_E | EAR | mg | 15.00 | 5.96 | 11.91 |
| Vit_K | AI | mcg | 120.00 | 53.34 | 106.68 |

TABLE 5
Recommendation Ranges with Upper Limit
for Males from 19 to 70 years old

| Nutrient | Type | Units | DV | Lower | Upper |
|---|---|---|---|---|---|
| Calcium | EAR | mg | 1000.00 | 322.57 | 820.13 |
| Dairy_total | HEP | cups | 3.00 | 3.00 | 3.00 |
| Fiber | AI | g | 34.80 | 9.42 | 26.51 |
| Food_Folate | EAR | mcg | 400.00 | 65.50 | 337.17 |
| Grain_total | HEP | oz | 6.00 | 6.00 | 6.00 |
| Magnesium | EAR | mg | 416.00 | 0.00 | 186.02 |
| Potassium | AI | mg | 3000.00 | 0.00 | 1099.11 |
| Veg_legumes | HEP | oz | 0.21 | 0.21 | 0.21 |
| Vit_A | EAR | mcg | 900.00 | 0.00 | 882.23 |
| Vit_D | EAR | mcg | 15.00 | 0.00 | 14.84 |
| Vit_E | EAR | mg | 15.00 | 0.00 | 11.91 |
| Vit_K | AI | mcg | 120.00 | 0.00 | 106.68 |

According to the Paleo diet constraints, dairy, grains and legumes recommendations will be ignored. In addition, the reported Vitamin E deficiency was ignored as it was caused by a bias in the NHANES data used for simulation and could not be attributed to the Paleo diet.

Validation of the Nutritional Recommendations

In table 6 analysis was performed including the above-mentioned nutritional recommendations in order to validate their accuracy. In the table below we can observe how the nutritional inadequacies of the Paleo diet are reduced when introducing the recommendations given by the algorithm.

TABLE 6
Validation of Paleo Nutritional Recommendations
for Males from 19 to 70 years old

| Nutrient | Type | Min.DRI | Mean.Inadequacy | Per.Deficient | Assessment |
|---|---|---|---|---|---|
| Carbohydrate | EAR | 130.0 | 4.97 | 0.73 | At Risk |
| Fiber | AI | 38.0 | 2.40 | 0.80 | Inadequate |
| Iron | EAR | 6.0 | −4.48 | 0.00 | Adequate |
| Sodium | AI | 1500.0 | −139.37 | 0.17 | At Risk |
| Veg_dark_green | HEP | 0.0 | −0.12 | 0.00 | Adequate |
| Vit_A | EAR | 625.0 | −247.29 | 0.00 | Adequate |
| Vit_E | EAR | 12.0 | 2.15 | 0.80 | Inadequate |
| Vit_K | AI | 120.0 | −45.08 | 0.09 | Adequate |
| Zinc | EAR | 9.4 | −4.26 | 0.01 | Adequate |

Specific Recommendations

The identified potential inadequate nutrient intakes of the Paleo diet can be resolved with the following dietary recommendations:

TABLE 7
Dietary Recommendations per Nutrient for males 19-70 years old

| Nutrient | Dietary recommendations |
|---|---|
| Calcium (mg) | Calcium in the amount of at least 850 mg per day |
| | For example: |
| | 135 g agar seaweed |
| | 87 g sesame seeds, whole seed |
| | 135 g raw tofu prepared with calcium sulfate |
| | 850 mg calcium supplement |
| Dairy_total | Not allowed |
| (cups) | |
| Fiber (g) | Fiber in the amount of at least 20 g per day |
| | For example: |
| | 200 g of oats, raw, |
| | 200 g passion fruit |
| Food_Folate | Food folate in the amount of at least 338 mcg per |
| (mcg) | day |
| | For example: |
| | 214 g mushrooms (dried shiitake), |
| | 174 g raw spinach, |
| | 338 mcg folic acid supplement |
| Magnesium (mg) | Magnesium in the amount of at least 200 mg per day |
| | For example: |
| | 25 g rice bran, crude |
| | 28.5 g hemp seed, hulled |
| | 53 g Brazil nuts |
| Potassium (mg) | Potassium in the amount of at least 1000 mg per day |
| | For example: |
| | 34 g chives, freeze dried |
| | 28 g radishes, oriental, dried |
| | 55.6 g soybeans, mature seeds, raw |
| Riboflavin (mg) | Riboflavin in the amount of at least 0.7 mg per day |
| | For example: |
| | 25 g beef liver, raw |
| | 19 g seaweed, spirulina, dried |
| Vit_A (mcg) | Vitamin A in the amount of at least 400 mcg per day |
| | For example: |
| | 1.3 g fish oil, cod liver |
| | 41.6 g sweet potato, baked, peel not eaten |
| | 47.6 g carrots, cooked, without fat added |
| Vit_K (mcg) | Vitamin K in the amount of at least 70 mcg per day |
| | For example: |
| | 13 g spinach, cooked, from fresh |
| | 18 g beet greens, cooked, from fresh |
| | 28 g collards, cooked, from fresh |
| Grain_total (oz) | Not allowed |
| Veg_legumes (oz) | Not allowed |
| Vit_D (mcg) | Vitamin D in the amount of at least 15 mcg, |
| | For example: |
| | 6 g cod liver fish oil, |
| | 100 g swordfish, |
| | 15 minutes exposure to sunlight |

Part 2—Results of Analysis for Males >70 Years Old

TABLE 8
shows the nutrients which have been identified as being adequate,
inadequate and at risk for males >70 years old

| | | | | Mean. | Per. | |
|---|---|---|---|---|---|---|
| | | | Min. | Inade- | Defi- | Assess- |
| Nutrient | Type | Units | DRI | quacy | cient | ment |
| Calcium | EAR | mg | 1000.000 | 689.022 | 1.00 | Inadequate |
| Dairy_total | HEP | cups | 3.000 | 3.000 | 1.00 | Inadequate |
| Fiber | AI | g | 30.000 | 17.090 | 1.00 | Inadequate |
| Food_Folate | EAR | μg | 320.000 | 163.301 | 1.00 | Inadequate |
| Grain_total | HEP | oz | 6.000 | 6.000 | 1.00 | Inadequate |
| Iron | EAR | mg | 6.000 | −3.248 | 0.00 | Adequate |
| Magnesium | EAR | mg | 350.000 | 25.309 | 0.80 | Inadequate |
| Niacin | EAR | mg | 12.000 | −10.064 | 0.00 | Adequate |
| Oils | HEP | NA | 24.600 | −1.340 | 0.28 | At Risk |
| Potassium | AI | mg | 3000.000 | 121.013 | 1.00 | At Risk |
| Riboflavin | EAR | mg | 1.100 | 0.048 | 0.60 | At Risk |
| Sodium | AI | mg | 1500.000 | −107.735 | 0.20 | At Risk |
| Veg_dark_green | HEP | oz | 0.214 | 0.076 | 0.80 | Inadequate |
| Veg_legumes | HEP | oz | 0.214 | 0.214 | 1.00 | Inadequate |
| Vit_A | EAR | μg | 625.000 | 99.547 | 1.00 | Inadequate |
| Vit_B6 | EAR | mg | 1.400 | −0.743 | 0.00 | Adequate |
| Vit_D | EAR | μg | 10.000 | 0.639 | 0.68 | At Risk |
| Vit_E | EAR | mg | 12.000 | 3.310 | 1.00 | Inadequate |
| Vit_K | AI | μg | 120.000 | 28.960 | 0.88 | Inadequate |
| Zinc | EAR | mg | 9.400 | −2.121 | 0.00 | Adequate |

Summary Quantiles on Intakes

Table 9 shows the summary statistics on intakes with quantiles for the nutrients of interest, along with the percentage of simulated days which are at or above the DRI. Note that for many of these the Max Intake is below the Min.DRI, indicating that there is close to 0% chance of adequacy.

TABLE 9
Summary Quantiles on Intakes for males >70 years old

| Nutrient | Units | Min.DRI | RDA | Min | 2.5% | 50% | 97.5% | Max | Pct.Adequate |
|---|---|---|---|---|---|---|---|---|---|
| Calcium | mg | 1000.000 | 1200.0 | 111.773 | 175.615 | 292.262 | 662.516 | 964.281 | 0.000 |
| Dairy_total | cups | 3.000 | NA | 0.000 | 0.000 | 0.000 | 0.000 | 0.001 | 0.000 |
| Fiber | g | 30.000 | NA | 4.286 | 7.676 | 14.547 | 25.372 | 40.638 | 0.003 |
| Food_Folate | μg | 320.000 | 400.0 | 28.910 | 62.835 | 167.944 | 332.584 | 442.611 | 0.042 |
| Grain_total | oz | 6.000 | NA | 0.000 | 0.000 | 0.000 | 0.000 | 2.323 | 0.000 |
| Magnesium | mg | 350.000 | 420.0 | 108.700 | 225.828 | 336.614 | 656.695 | 854.220 | 0.456 |
| Potassium | mg | 3000.000 | NA | 946.380 | 1918.481 | 2952.473 | 4336.928 | 5737.225 | 0.456 |
| Riboflavin | mg | 1.100 | 1.3 | 0.153 | 0.624 | 1.112 | 2.222 | 3.589 | 0.521 |
| Veg_legumes | oz | 0.214 | NA | 0.000 | 0.000 | 0.000 | 0.000 | 0.000 | 0.000 |
| Vit_A | μg | 625.000 | 900.0 | 3.310 | 19.697 | 513.326 | 1041.027 | 1475.112 | 0.243 |
| Vit_D | μg | 10.000 | 20.0 | 0.000 | 0.176 | 5.015 | 31.771 | 73.621 | 0.358 |
| Vit_E | mg | 12.000 | 15.0 | 1.397 | 3.251 | 8.122 | 23.256 | 33.897 | 0.225 |
| Vit_K | μg | 120.000 | NA | 3.642 | 13.506 | 50.300 | 478.227 | 901.316 | 0.224 |

Amount of Inadequacy

Table 10 shows the amount of inadequacy, below the DRI for each of the quantiles. If the values are negative it means that the intake tends to be above the DRI.

TABLE 10
Amount of Inadequacy by Quantiles for males >70 years old

| Nutrient | Units | Min.DRI | 2.5% Gap | 50% Gap | 97.5% Gap |
|---|---|---|---|---|---|
| Calcium | mg | 1000.000 | 824.385 | 707.738 | 337.484 |
| Dairy_total | cups | 3.000 | 3.000 | 3.000 | 3.000 |
| Fiber | g | 30.000 | 22.324 | 15.453 | 4.628 |
| Food_Folate | mcg | 320.000 | 257.165 | 152.056 | −12.584 |
| Grain_total | oz | 6.000 | 6.000 | 6.000 | 6.000 |
| Magnesium | mg | 350.000 | 124.172 | 13.386 | −306.695 |
| Potassium | mg | 3000.000 | 1081.519 | 47.527 | −1336.928 |
| Riboflavin | mg | 1.100 | 0.476 | −0.012 | −1.122 |
| Veg_legumes | oz | 0.214 | 0.214 | 0.214 | 0.214 |
| Vit_A | mcg | 625.000 | 605.303 | 111.674 | −416.027 |
| Vit_D | mcg | 10.000 | 9.824 | 4.985 | −21.771 |
| Vit_E | mg | 12.000 | 8.749 | 3.878 | −11.256 |
| Vit_K | mcg | 120.000 | 106.494 | 69.700 | −358.227 |

Nutritional Recommendations

Table 11 shows the dietary recommendations and Table 12 shows the recommendation ranges. For recommendations we took the 2.5% quantile as the intake, the EAR (or Recommended daily Allowance (RDA), if available) as the goal, and divided it by 2 to get to recommendation per 1000 kCal, ensuring that the suggestion will be below the Max DRI.

Note that the food group recommendations (Dairy, Grains and Legumes) cannot be made because they are against the rules of the Paleo diet.

TABLE 11
Recommendation ranges for 1000 kCal
and 2000 kCal for males >70 years old

| Nutrient | Type | Units | DV | 1000 kCal Rec | 2000 kCal Rec |
|---|---|---|---|---|---|
| Calcium | EAR | mg | 1200.00 | 512.19 | 1024.38 |
| Dairy_total | HEP | cups | 3.00 | 1.50 | 3.00 |
| Fiber | AI | g | 30.00 | 11.16 | 22.32 |
| Food_Folate | EAR | mcg | 400.00 | 168.58 | 337.17 |
| Grain_total | HEP | oz | 6.00 | 3.00 | 6.00 |
| Magnesium | EAR | mg | 420.00 | 97.09 | 194.17 |
| Potassium | AI | mg | 3000.00 | 540.76 | 1081.52 |
| Riboflavin | EAR | mg | 1.30 | 0.34 | 0.68 |
| Veg_legumes | HEP | oz | 0.21 | 0.11 | 0.21 |
| Vit_A | EAR | mcg | 900.00 | 440.15 | 880.30 |
| Vit_D | EAR | mcg | 20.00 | 9.91 | 19.82 |
| Vit_E | EAR | mg | 15.00 | 5.87 | 11.75 |
| Vit_K | AI | mcg | 120.00 | 53.25 | 106.49 |

TABLE 12
Recommendation Ranges with Upper
Limit for males >70 years old

| Nutrient | Type | Units | DV | Lower | Upper |
|---|---|---|---|---|---|
| Calcium | EAR | mg | 1200.00 | 537.48 | 1024.38 |
| Dairy_total | HEP | cups | 3.00 | 3.00 | 3.00 |
| Fiber | AI | g | 30.00 | 4.63 | 22.32 |
| Food_Folate | EAR | mcg | 400.00 | 67.42 | 337.17 |
| Grain_total | HEP | oz | 6.00 | 6.00 | 6.00 |
| Magnesium | EAR | mg | 420.00 | 0.00 | 194.17 |
| Potassium | AI | mg | 3000.00 | 0.00 | 1081.52 |
| Riboflavin | EAR | mg | 1.30 | 0.00 | 0.68 |
| Veg_legumes | HEP | oz | 0.21 | 0.21 | 0.21 |
| Vit_A | EAR | mcg | 900.00 | 0.00 | 880.30 |
| Vit_D | EAR | mcg | 20.00 | 0.00 | 19.82 |
| Vit_E | EAR | mg | 15.00 | 0.00 | 11.75 |
| Vit_K | AI | mcg | 120.00 | 0.00 | 106.49 |

According to the Paleo diet constraints, dairy, grains and legumes recommendations will be ignored. In addition, the reported Vitamin E deficiency was ignored as it was caused by a bias in the NHANES data used for simulation and could not be attributed to the Paleo diet.

Validation of the Nutritional Recommendations

The analysis was performed including the above-mentioned nutritional recommendations in order to validate their accuracy. In the table below we can observe how the nutritional inadequacies of the Paleo diet are reduced when introducing the recommendations given by the algorithm.

TABLE 13
Validation of Paleo Nutritional Recommendations for males >70 years old

| Nutrient | Type | Min.DRI | Mean.Inadequacy | Per.Deficient | Assessment |
|---|---|---|---|---|---|
| Calcium | EAR | 1000.0 | −182.97 | 0.00 | Adequate |
| Carbohydrate | EAR | 130.0 | 4.34 | 0.68 | At Risk |
| Fiber | AI | 30.0 | −4.93 | 0.00 | Adequate |
| Iron | EAR | 6.0 | −4.17 | 0.00 | Adequate |
| Sodium | AI | 1500.0 | −131.30 | 0.18 | At Risk |
| Veg_dark_green | HEP | 0.0 | −0.13 | 0.00 | Adequate |
| Vit_A | EAR | 625.0 | −261.30 | 0.00 | Adequate |
| Vit_B6 | EAR | 1.4 | −0.81 | 0.00 | Adequate |
| Vit_D | EAR | 10.0 | −14.40 | 0.00 | Adequate |
| Vit_E | EAR | 12.0 | 2.46 | 0.85 | Inadequate |
| Vit_K | AI | 120.0 | −44.12 | 0.09 | Adequate |
| Zinc | EAR | 9.4 | −3.70 | 0.01 | Adequate |

Specific Recommendations

The identified potential inadequate nutrient intakes of the Paleo diet can be resolved with the following dietary recommendations:

TABLE 14
Dietary Recommendations per Nutrient for males >70 years old

| Nutrient | Dietary recommendations |
|---|---|
| Calcium (mg) | Calcium in the amount of at least |
| | 850 mg per day |
| | For example: |
| | 135 g agar seaweed |
| | 87 g sesame seeds, whole seed |
| | 135 g raw tofu prepared with calcium |
| | sulfate |
| | 850 mg calcium supplement |
| Dairy_total (cups) | Not allowed |
| Fiber (g) | Fiber in the amount of at least |
| | 20 g per day |
| | For example: |
| | 200 g of oats, raw |
| | 200 g passion fruit |
| Food_Folate (mcg) | Food folate in the amount of at least |
| | 338 mcg per day |
| | For example: |
| | 214 g mushrooms (dried shiitake) |
| | 174 g raw spinach |
| | 338 mcg folic acid supplement |
| Magnesium (mg) | Magnesium in the amount of at least |
| | 200 mg per day |
| | For example: |
| | 25 g rice bran, crude |
| | 28.5 g hemp seed, hulled |
| | 53 g Brazil nuts |
| Potassium (mg) | Potassium in the amount of at least |
| | 1000 mg per day |
| | For example: |
| | 34 g chives, freeze dried |
| | 28 g radishes, oriental, dried |
| | 55.6 g soybeans, mature seeds, raw |
| Riboflavin (mg) | Riboflavin in the amount of at least |
| | 0.7 mg per day |
| | For example: |
| | 25 g beef liver, raw |
| | 19 g seaweed, spirulina, dried |
| Vit_K (mcg) | Vitamin K in the amount of at least |
| | 70 mcg per day |
| | For example: |
| | 13 g spinach, cooked, from fresh |
| | 18 g beet greens, cooked, from fresh |
| | 28 g collards, cooked, from fresh |
| Vit_A (mcg) | Vitamin A in the amount of at least |
| | 400 mcg per day |
| | For example: |
| | 1.3 g fish oil, cod liver |
| | 41.6 g sweet potato, baked, peel not eaten |
| | 47.6 g carrots, cooked, without fat added |
| Grain_total (oz) | Not allowed |
| Veg_legumes (oz) | Not allowed |
| Vit_D (mcg) | Vitamin D in the amount of at least |
| | 15 mcg per day |
| | For example: |
| | 6 g cod liver fish oil |
| | 100 g swordfish |
| | 15 minutes exposure to sunlight |

Part 3—Results of Analysis for Females from 19-50 Years Old

TABLE 15
shows the nutrients which have been identified as being adequate,
inadequate and at risk for females from 19-50 years old

| | | | | Mean. | Per. | |
|---|---|---|---|---|---|---|
| | | | Min. | Inade- | Defi- | Assess- |
| Nutrient | Type | Units | DRI | quacy | cient | ment |
| Calcium | EAR | mg | 800.000 | 495.794 | 1.00 | Inadequate |
| Dairy_total | HEP | cups | 0.000 | 0.000 | 0.96 | At Risk |
| Dairy_total | HEP | cups | 3.000 | 3.000 | 1.00 | Inadequate |
| Fiber | AI | g | 25.000 | 10.917 | 1.00 | Inadequate |
| Food_Folate | EAR | μg | 320.000 | 144.837 | 1.00 | Inadequate |
| Grain_total | HEP | oz | 6.000 | 6.000 | 1.00 | Inadequate |
| Iron | EAR | mg | 8.100 | −2.622 | 0.00 | Adequate |
| Magnesium | EAR | mg | 261.000 | −111.136 | 0.00 | Adequate |
| Oils | HEP | NA | 26.400 | −3.775 | 0.12 | At Risk |
| Potassium | AI | mg | 2300.000 | −635.743 | 0.00 | Adequate |
| Riboflavin | EAR | mg | 0.900 | −0.227 | 0.20 | Adequate |
| Sodium | AI | mg | 1500.000 | −201.704 | 0.08 | Adequate |
| Veg_dark_green | HEP | oz | 0.214 | 0.047 | 0.60 | Inadequate |
| Veg_legumes | HEP | oz | 0.214 | 0.214 | 1.00 | Inadequate |
| Vit_A | EAR | μg | 500.000 | −38.045 | 0.40 | At Risk |
| Vit_D | EAR | μg | 10.000 | 0.175 | 0.60 | At Risk |
| Vit_E | EAR | mg | 12.000 | 2.711 | 1.00 | Inadequate |
| Vit_K | AI | μg | 90.000 | −22.237 | 0.28 | Inadequate |

Summary Quantiles on Intakes

Table 16 shows the summary statistics on intakes with quantiles for the nutrients of interest, along with the percentage of simulated days which are at or above the DRI. Note that for many of these the Max Intake is below the Min.DRI, indicating that there is close to 0% chance of adequacy.

TABLE 16
Summary Quantiles on Intakes for females from 19-50 years old

| Nutrient | Units | Min.DRI | RDA | Min | 2.5% | 50% | 97.5% | Max | Pct.Adequate |
|---|---|---|---|---|---|---|---|---|---|
| Calcium | mg | 800.000 | 1000.0 | 106.257 | 177.278 | 281.521 | 697.241 | 999.768 | 0.002 |
| Dairy_total | cups | 0.000 | NA | 0.000 | 0.000 | 0.000 | 0.000 | 0.001 | 0.000 |
| Dairy_total | cups | 3.000 | NA | 0.000 | 0.000 | 0.000 | 0.000 | 0.001 | 0.000 |
| Fiber | g | 25.000 | NA | 4.353 | 7.548 | 14.102 | 23.980 | 30.173 | 0.020 |
| Food_Folate | μg | 320.000 | 400.0 | 31.960 | 53.426 | 161.827 | 309.418 | 465.851 | 0.020 |
| Grain_total | oz | 6.000 | NA | 0.000 | 0.000 | 0.000 | 0.000 | 1.306 | 0.000 |
| Riboflavin | mg | 0.900 | 1.1 | 0.394 | 0.592 | 1.095 | 1.971 | 2.429 | 0.716 |
| Veg_legumes | oz | 0.214 | NA | 0.000 | 0.000 | 0.000 | 0.000 | 0.000 | 0.000 |
| Vit_A | μg | 500.000 | 700.0 | 3.310 | 10.301 | 534.564 | 1041.028 | 2850.993 | 0.582 |
| Vit_D | μg | 10.000 | 15.0 | 0.000 | 0.153 | 5.006 | 31.891 | 77.203 | 0.367 |
| Vit_E | mg | 12.000 | 15.0 | 1.397 | 2.760 | 7.768 | 23.256 | 29.035 | 0.164 |
| Vit_K | μg | 90.000 | NA | 5.424 | 12.852 | 47.807 | 474.019 | 708.296 | 0.224 |

Amount of Inadequacy

Table 17 shows the amount of inadequacy, below the DRI for each of the quantiles. If the values are negative it means that the intake tends to be above the DRI.

TABLE 17
Amount of Inadequacy by Quantiles
for females from 19-50 years old

| Nutrient | Units | Min.DRI | 2.5% Gap | 50% Gap | 97.5% Gap |
|---|---|---|---|---|---|
| Calcium | mg | 800.000 | 622.722 | 518.479 | 102.759 |
| Dairy_total | cups | 0.000 | 0.000 | 0.000 | 0.000 |
| Dairy_total | cups | 3.000 | 3.000 | 3.000 | 3.000 |
| Fiber | g | 25.000 | 17.452 | 10.898 | 1.020 |
| Food_Folate | mcg | 320.000 | 266.574 | 158.173 | 10.582 |
| Grain_total | oz | 6.000 | 6.000 | 6.000 | 6.000 |
| Riboflavin | mg | 0.900 | 0.308 | −0.195 | −1.071 |
| Veg_legumes | oz | 0.214 | 0.214 | 0.214 | 0.214 |
| Vit_A | mcg | 500.000 | 489.699 | −34.564 | −541.028 |
| Vit_D | mcg | 10.000 | 9.847 | 4.994 | −21.891 |
| Vit_E | mg | 12.000 | 9.240 | 4.232 | −11.256 |
| Vit_K | mcg | 90.000 | 77.148 | 42.193 | −384.019 |

Nutritional Recommendations

Table 18 shows the dietary recommendations and Table 19 shows the recommendation ranges. For recommendations we took the 2.5% quantile as the intake, the EAR (or Recommended daily Allowance (RDA), if available) as the goal, and divided it by 2 to get to recommendation per 1000 kCal, ensuring that the suggestion will be below the Max DRI.

Note that the food group recommendations (Dairy, Grains and Legumes) cannot be made because they are against the rules of the Paleo diet.

TABLE 18
Recommendation ranges for 1000 kCal and 2000
kCal for females from 19-50 years old

| | | | | 1000 kCal | 2000 kCal |
|---|---|---|---|---|---|
| Nutrient | Type | Units | DV | Rec | Rec |
| Calcium | EAR | mg | 1000.00 | 411.36 | 822.72 |
| Dairy_total | HEP | cups | 0.00 | 0.00 | 0.00 |
| Dairy_total | HEP | cups | 3.00 | 1.50 | 3.00 |
| Fiber | AI | g | 25.00 | 8.73 | 17.45 |
| Food_Folate | EAR | mcg | 400.00 | 173.29 | 346.57 |
| Grain_total | HEP | oz | 6.00 | 3.00 | 6.00 |
| Riboflavin | EAR | mg | 1.10 | 0.25 | 0.51 |
| Veg_legumes | HEP | oz | 0.21 | 0.11 | 0.21 |
| Vit_A | EAR | mcg | 700.00 | 344.85 | 689.70 |
| Vit_D | EAR | mcg | 15.00 | 7.42 | 14.85 |
| Vit_E | EAR | mg | 15.00 | 6.12 | 12.24 |
| Vit_K | AI | mcg | 90.00 | 38.57 | 77.15 |

TABLE 19
Recommendation Ranges with Upper Limit
for females from 19-50 years old

| Nutrient | Type | Units | DV | Lower | Upper |
|---|---|---|---|---|---|
| Calcium | EAR | mg | 1000.00 | 302.76 | 822.72 |
| Dairy_total | HEP | cups | 0.00 | 3.00 | 0.00 |
| Dairy_total | HEP | cups | 3.00 | 3.00 | 3.00 |
| Fiber | AI | g | 25.00 | 1.02 | 17.45 |
| Food_Folate | EAR | mcg | 400.00 | 90.58 | 346.57 |
| Grain_total | HEP | oz | 6.00 | 6.00 | 6.00 |
| Riboflavin | EAR | mg | 1.10 | 0.00 | 0.51 |
| Veg_legumes | HEP | oz | 0.21 | 0.21 | 0.21 |
| Vit_A | EAR | mcg | 700.00 | 0.00 | 689.70 |
| Vit_D | EAR | mcg | 15.00 | 0.00 | 14.85 |
| Vit_E | EAR | mg | 15.00 | 0.00 | 12.24 |
| Vit_K | AI | mcg | 90.00 | 0.00 | 77.15 |

According to the Paleo diet constraints, dairy, grains and legumes recommendations were ignored. In addition, the reported Vitamin E deficiency was ignored as it was caused by a bias in the NHANES data used for simulation and could not be attributed to the Paleo diet.

Validation of the Nutritional Recommendations

The analysis was performed including the above-mentioned nutritional recommendations in order to validate their accuracy. In the table below we can observe how the nutritional inadequacies of the Paleo diet are reduced when introducing the recommendations given by the algorithm.

TABLE 20
Validation of Paleo Nutritional Recommendations
for females from 19-50 years old

| Nutrient | Type | Min.DRI | Mean.Inadequacy | Per.Deficient | Assessment |
|---|---|---|---|---|---|
| Carbohydrate | EAR | 130.0 | 8.41 | 0.80 | At Risk |
| Fiber | AI | 25.0 | −6.47 | 0.00 | Adequate |
| Iron | EAR | 8.1 | −2.02 | 0.16 | Adequate |
| Magnesium | EAR | 265.0 | −95.31 | 0.00 | Adequate |
| Potassium | AI | 2300.0 | −601.88 | 0.00 | Adequate |
| Riboflavin | EAR | 0.9 | −0.22 | 0.10 | Adequate |
| Sodium | AI | 1500.0 | −93.41 | 0.26 | At Risk |
| Veg_dark_green | HEP | 0.0 | −0.11 | 0.00 | Adequate |
| Vit_A | EAR | 500.0 | −200.49 | 0.00 | Adequate |
| Vit_E | EAR | 12.0 | 3.16 | 1.00 | Inadequate |

Specific Recommendations

The identified potential inadequate nutrient intakes of the Paleo diet can be resolved with the following dietary recommendations:

TABLE 21
Dietary Recommendations per Nutrient for females 19-50 years old

| Nutrient | Dietary recommendations |
|---|---|
| Calcium (mg) | Calcium in the amount of at least |
| | 825 mg per day |
| | For example: |
| | 131 g agar seaweed |
| | 84.4 g sesame seeds, whole seed |
| | 131 g raw tofu prepared with calcium |
| | sulfate |
| | 825 mg calcium supplement |
| Dairy_total (cups) | Not allowed |
| Fiber (g) | Fiber in the amount of at least |
| | 17 g per day |
| | For example: |
| | 144.5 g of oats, raw |
| | 144.5 g passion fruit |
| Food_Folate (mcg) | Food folate in the amount of at least |
| | 350 mcg per day |
| | For example: |
| | 221.5 g mushrooms (dried shiitake) |
| | 180 g raw spinach |
| | 350 mcg folic acid supplement |
| Grain_total (oz) | Not allowed |
| Veg_legumes (oz) | Not allowed |
| Vit_K (mcg) | Vitamin K in the amount of at least |
| | 78 mcg per day |
| | For example: |
| | 14.5 g spinach, cooked, from fresh |
| | 20 g beet greens, cooked, from fresh |
| | 30 g collards, cooked, from fresh |
| Vit_A (mcg) | Vitamin A in the amount of at least |
| | 200 mcg per day |
| | For example: |
| | 0.65 g fish oil, cod liver |
| | 20.8 g sweet potato, baked, peel not |
| | eaten |
| | 24 g carrots, cooked, without fat added |
| Vit_D (mcg) | Vitamin D in the amount of at least |
| | 15 mcg per day |
| | For example: |
| | 6 g cod liver fish oil, |
| | 100 g swordfish, |
| | 15 minutes exposure to sunlight |

Part 4—Results of Analysis for Females >50 Years Old

TABLE 22
shows the nutrients which have been identified as being adequate,
inadequate and at risk for females >50 years old

| | | | | Mean. | Per. | |
|---|---|---|---|---|---|---|
| | | | Min. | Inade- | Defi- | Assess- |
| Nutrient | Type | Units | DRI | quacy | cient | ment |
| Calcium | EAR | mg | 1000.000 | 630.521 | 1.00 | Inadequate |
| Dairy_total | HEP | cups | 3.000 | 3.000 | 1.00 | Inadequate |
| Fiber | AI | g | 21.000 | 6.135 | 1.00 | Inadequate |
| Food_Folate | EAR | μg | 320.000 | 170.668 | 1.00 | Inadequate |
| Grain_total | HEP | oz | 6.000 | 6.000 | 1.00 | Inadequate |
| Iron | EAR | mg | 5.000 | −4.516 | 0.00 | Adequate |
| Magnesium | EAR | mg | 265.000 | −83.482 | 0.00 | Adequate |
| Oils | HEP | NA | 23.200 | −4.499 | 0.20 | Adequate |
| Riboflavin | EAR | mg | 0.900 | −0.205 | 0.00 | Adequate |
| Sodium | AI | mg | 1500.000 | 14.887 | 0.44 | At Risk |
| Veg_legumes | HEP | oz | 0.214 | 0.214 | 1.00 | Inadequate |
| Vit_A | EAR | μg | 500.000 | 37.073 | 0.60 | At Risk |
| Vit_D | EAR | μg | 10.000 | 1.132 | 0.64 | At Risk |
| Vit_E | EAR | mg | 12.000 | 3.609 | 1.00 | Inadequate |
| Vit_K | AI | μg | 90.000 | 28.545 | 0.84 | Inadequate |

Summary Quantiles on Intakes

Table 23 shows the summary statistics on intakes with quantiles for the nutrients of interest, along with the percentage of simulated days which are at or above the DRI. Note that for many of these the Max Intake is below the Min.DRI, indicating that there is close to 0% chance of adequacy.

TABLE 23
Summary Quantiles on Intakes for females >50 years old

| Nutrient | Units | Min.DR | RD | Min | 2.5% | 50% | 97.5% | Max | Pct.Adequate |
|---|---|---|---|---|---|---|---|---|---|
| Calcium | mg | 1000.000 | 1200 | 106.257 | 183.342 | 298.200 | 697.241 | 902.406 | 0.000 |
| Dairy_total | cups | 3.000 | NA | 0.000 | 0.000 | 0.000 | 0.000 | 0.000 | 0.000 |
| Fiber | g | 21.000 | NA | 5.706 | 8.288 | 14.640 | 25.380 | 30.173 | 0.050 |
| Food_Folate | μg | 320.000 | 400 | 31.960 | 53.886 | 157.550 | 268.730 | 356.611 | 0.002 |
| Grain_total | oz | 6.000 | NA | 0.000 | 0.000 | 0.000 | 0.000 | 0.850 | 0.000 |
| Veg_legumes | oz | 0.214 | NA | 0.000 | 0.000 | 0.000 | 0.000 | 0.000 | 0.000 |
| Vit_A | μg | 500.000 | 700 | 3.310 | 8.010 | 509.604 | 1041.027 | 1347.770 | 0.522 |
| Vit_D | μg | 10.000 | 17 | 0.000 | 0.153 | 3.874 | 30.969 | 77.203 | 0.360 |
| Vit_E | mg | 12.000 | 15 | 1.397 | 2.738 | 7.769 | 18.243 | 22.535 | 0.159 |
| Vit_K | μg | 90.000 | NA | 5.424 | 10.488 | 37.510 | 335.231 | 689.888 | 0.121 |

Amount of Inadequacy

Table 24 shows the amount of inadequacy, below the DRI for each of the quantiles. If the values are negative it means that the intake tends to be above the DRI.

TABLE 24
Amount of Inadequacy by Quantiles for females >50 years old

| Nutrient | Units | Min.DRI | 2.5% Gap | 50% Gap | 97.5% Gap |
|---|---|---|---|---|---|
| Calcium | mg | 1000.000 | 816.658 | 701.800 | 302.759 |
| Dairy_total | cups | 3.000 | 3.000 | 3.000 | 3.000 |
| Fiber | g | 21.000 | 12.712 | 6.360 | −4.380 |
| Food_Folate | mcg | 320.000 | 266.114 | 162.450 | 51.270 |
| Grain_total | oz | 6.000 | 6.000 | 6.000 | 6.000 |
| Veg_legumes | oz | 0.214 | 0.214 | 0.214 | 0.214 |
| Vit_A | mcg | 500.000 | 491.990 | −9.604 | −541.027 |
| Vit_D | mcg | 10.000 | 9.847 | 6.126 | −20.969 |
| Vit_E | mg | 12.000 | 9.262 | 4.231 | −6.243 |
| Vit_K | mcg | 90.000 | 79.512 | 52.490 | −245.231 |

Nutritional Recommendations

Table 25 shows the dietary recommendations and Table 26 shows the recommendation ranges. For recommendations we took the 2.5% quantile as the intake, the EAR (or Recommended daily Allowance (RDA), if available) as the goal, and divided it by 2 to get to recommendation per 1000 kCal, ensuring that the suggestion will be below the Max DRI.

Note that the food group recommendations (Dairy, Grains and Legumes) cannot be made because they are against the rules of the Paleo diet.

TABLE 25
Recommendation ranges for 1000 kCal and
2000 kCal for females >50 years old

| | | | | 1000 kCal | 2000 kCal |
|---|---|---|---|---|---|
| Nutrient | Type | Units | DV | Rec | Rec |
| Calcium | EAR | mg | 1200.00 | 508.33 | 1016.66 |
| Dairy_total | HEP | cups | 3.00 | 1.50 | 3.00 |
| Fiber | AI | g | 21.00 | 6.36 | 12.71 |
| Food_Folate | EAR | mcg | 400.00 | 173.06 | 346.11 |
| Grain_total | HEP | oz | 6.00 | 3.00 | 6.00 |
| Veg_legumes | HEP | oz | 0.21 | 0.11 | 0.21 |
| Vit_A | EAR | mcg | 700.00 | 346.00 | 691.99 |
| Vit_D | EAR | mcg | 17.00 | 8.42 | 16.85 |
| Vit_E | EAR | mg | 15.00 | 6.13 | 12.26 |
| Vit_K | AI | mcg | 90.00 | 39.76 | 79.51 |

TABLE 26
Recommendation Ranges with Upper
Limit for females >50 years old

| Nutrient | Type | Units | DV | Lower | Upper |
|---|---|---|---|---|---|
| Calcium | EAR | mg | 1200.00 | 502.76 | 1016.66 |
| Dairy_total | HEP | cups | 3.00 | 3.00 | 3.00 |
| Fiber | AI | g | 21.00 | 0.00 | 12.71 |
| Food_Folate | EAR | mcg | 400.00 | 131.27 | 346.11 |
| Grain_total | HEP | oz | 6.00 | 6.00 | 6.00 |
| Veg_legumes | HEP | oz | 0.21 | 0.21 | 0.21 |
| Vit_A | EAR | mcg | 700.00 | 0.00 | 691.99 |
| Vit_D | EAR | mcg | 17.00 | 0.00 | 16.85 |
| Vit_E | EAR | mg | 15.00 | 0.00 | 12.26 |
| Vit_K | AI | mcg | 90.00 | 0.00 | 79.51 |

According to the Paleo diet constraints, dairy, grains and legumes recommendations were ignored. In addition, the reported Vitamin E deficiency was ignored as it was caused by a bias in the NHANES data used for simulation and could not be attributed to the Paleo diet.

Validation of the Nutritional Recommendations

The analysis was performed including the above-mentioned nutritional recommendations in order to validate their accuracy. In the table below we can observe how the nutritional inadequacies of the Paleo diet are reduced when introducing the recommendations given by the algorithm.

TABLE 27
Validation of Paleo Nutritional Recommendations for females >50 years old

| Nutrient | Type | Min.DRI | Mean.Inadequacy | Per.Deficient | Assessment |
|---|---|---|---|---|---|
| Calcium | EAR | 1000.0 | −369.48 | 0.00 | Adequate |
| Carbohydrate | EAR | 130.0 | 9.72 | 0.80 | Inadequate |
| Fiber | AI | 21.0 | −7.86 | 0.00 | Adequate |
| Iron | EAR | 5.0 | −4.52 | 0.00 | Adequate |
| Magnesium | EAR | 265.0 | −83.48 | 0.00 | Adequate |
| Riboflavin | EAR | 0.9 | −0.20 | 0.00 | Adequate |
| Sodium | AI | 1500.0 | 14.89 | 0.44 | At Risk |
| Veg_dark_green | HEP | 0.0 | −0.05 | 0.00 | Adequate |
| Vit_A | EAR | 500.0 | −362.93 | 0.00 | Adequate |
| Vit_E | EAR | 12.0 | 3.61 | 1.00 | Inadequate |

Specific Recommendations

The identified potential inadequate nutrient intakes of the Paleo diet can be resolved with the following dietary recommendations:

TABLE 28
Dietary Recommendations per Nutrient for females >50 years old

| Nutrient | Dietary recommendations |
|---|---|
| Calcium (mg) | Calcium in the amount of at least |
| | 1000 mg per day |
| | For example: |
| | 159 g agar seaweed |
| | 102 g sesame seeds, whole seed |
| | 159 g raw tofu prepared with calcium |
| | sulfate |
| Dairy_total (cups) | Not allowed |
| Fiber (g) | Fiber in the amount of at least |
| | 14 g per day |
| | For example: |
| | 144.6 g of oats, raw |
| | 144.6 g passion fruit |
| Food_Folate (mcg) | Food folate in the amount of at least |
| | 360 mcg per day |
| | For example: |
| | 228 g mushrooms (dried shiitake) |
| | 185.7 g raw spinach |
| | 228 g agar seaweed |
| | 360 mcg folic acid supplement |
| Grain_total (oz) | Not allowed |
| Veg_legumes (oz) | Not allowed |
| Vit_K (mcg) | Vitamin K in the amount of at least |
| | 78 mcg per day |
| | For example: |
| | 14.5 g spinach, cooked, from fresh |
| | 20 g beet greens, cooked, from fresh |
| | 30 g collards, cooked, from fresh |
| Vit_A (mcg) | Vitamin A in the amount of at least |
| | 400 mcg per day |
| | For example: |
| | 1.3 g fish oil, cod liver |
| | 41.6 g sweet potato, baked, peel not eaten |
| | 47.6 g carrots, cooked, without fat added |
| Vit_D (mcg) | Vitamin D in the amount of at least |
| | 17 mcg per day |
| | For example: |
| | 6 g cod liver fish oil |
| | 100 g swordfish |
| | 15 minutes exposure to sunlight |

1. (canceled)

2. Method according to claim 17 wherein said composition comprises at least one component selected from the group consisting calcium, fiber, folate, magnesium, potassium, Vitamin A, Vitamin D, Vitamin E, Vitamin K and riboflavin.

3. Method according to claim 17 wherein said composition for men 19-70 years old comprises between 322 to 820 mg/day calcium; between 9 to 27 g/day fiber; 66 to 337 mcg/day folate; up to 186 mg/day magnesium; up to 1099 mg/day potassium; up to 882 mcg/day Vitamin A; up to 15 mcg/day Vitamin D; up to 12 mg/day Vitamin E; and up to 107 mcg/day Vitamin K.

4. Method according to claim 17 wherein said composition for men greater than 70 years old comprises between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day Vitamin K.

5. Method according to claim 17 wherein said composition for women 19-50 years old comprises between 303 to 823 mg/day calcium; between 1 to 17 g/day fiber; between 91 to 347 mcg/day folate; up to 0.5 mg/day riboflavin, up to 690 mcg/day Vitamin A; up to 15 mcg/day Vitamin D; up to 12 mg/day Vitamin E; and up to 77 mcg/day Vitamin K.

6. Method according to claim 17 wherein said composition for women greater than 50 years old comprises between 503 to 1017 mg/day calcium; up to 13 g/day fiber; between 131 to 346 mcg/day folate; up to 692 mcg/day Vitamin A; up to 17 mcg/day Vitamin D; up to 12 mg/day Vitamin E; and up to 80 mcg/day Vitamin K.

7. Method according to claim 17 wherein said composition for men 19-70 years old consists of: between 322 to 820 mg/day calcium; between 9 to 27 g/day fiber; 66 to 337 mcg/day folate; up to 186 mg/day magnesium; up to 1099 mg/day potassium; up to 882 mcg/day vitamin A; up to 15 mcg/day Vitamin D; up to 12 mg/day Vitamin E; and up to 107 mcg/day vitamin K.

8. Method according to claim 17 wherein said composition for men greater than 70 years old consists of: between 537 to 1024 mg/day calcium; between 5 to 22 g/day fiber; between 67 to 337 mcg/day folate; up to 194 mg/day magnesium; up to 1082 mg/day potassium; up to 0.7 mg/day riboflavin, up to 880 mcg/day vitamin A; up to 20 mcg/day Vitamin D; up to 12 mg/day Vitamin E; and up to 106 mcg/day vitamin K.

9. Method according to claim 17 wherein said composition for women 19-50 years old consists of: between 303 to 823 mg/day calcium; between 1 to 17 g/day fiber; between 91 to 347 mcg/day folate; up to 0.5 mg/day riboflavin, up to 690 mcg/day vitamin A; up to 15 mcg/day Vitamin D; up to 12 mg/day Vitamin E; and up to 77 mcg/day vitamin K.

10. Method according to claim 17 wherein said composition for women greater than 50 years old consists of: between 503 to 1017 mg/day calcium; up to 13 g/day fiber; between 131 to 346 mcg/day folate; up to 692 mcg/day vitamin A; up to 17 mcg/day Vitamin D; up to 12 mg/day Vitamin E; and up to 80 mcg/day vitamin K.

11. Method according to claim 17 wherein said composition is an oral nutrient supplement.

12. Method according to claim 17 wherein said composition is administered as a single supplement daily.

13. Method according to claim 17 wherein said composition is administered as multiple supplements daily.

14. Method according to claim 17 in combination with dietary or menu/meal recommendations conforming to a Paleo diet.

15. Method according to claim 17 wherein said composition comprises a mixture of food products, beverage products and oral nutrient supplements.

16. (canceled)

17. Method of reducing inadequate nutrient intakes of individuals on a Paleo restricted diet said method comprising administering a composition selected from the group consisting of: a food product, beverage product, a food supplement, an oral nutritional supplement (ONS), a medical food, and combinations thereof.
